(19) United States
(12) Patent Application Publication
(10) Pub. No.: US 2005/0013039 A1
(43) Pub. Date: Jan. 20, 2005

(54) Magnetic disk drive

(75) Inventors: Satoshi Matsumura, Kanagawa (JP); Kenji Kuroki, Kanagawa (JP); Hiroki Kitahori, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Netherlands, B.V., AZ Amsterdam (NL)

(21) Appl. No.: 10/892,511

(22) Filed: Jul. 14, 2004

(30) Foreign Application Priority Data
Jul. 14, 2003 (JP) 2003-196289

(51) Int. Cl. G11B 17/00

(52) U.S. Cl. 360/97.01

(57) ABSTRACT

When attaching/detaching a magnetic disk drive to/from the slot of a PC card, the user holds the drive with his or her fingers and thumb, applying figure pressure to the portion of the drive in which the magnetic head is located, which might lead to damage to the magnetic head and the magnetic disk in the worst case. A magnetic disk drive according to one embodiment of the present invention comprises a magnetic disk, a spindle motor for holding and rotating the magnetic disk, a magnetic head for writing/reading information to/from the magnetic disk, an actuator having the magnetic head mounted on one end thereof, for moving the magnetic head in a radial direction of the magnetic disk, and a circuit board having electronic components thereon. A connector for transmitting signals from the magnetic head to an external device is attached to a side of the circuit board close to the magnetic head.

### BACKGROUND OF THE INVENTION

The present invention relates to a magnetic disk drive, and more particularly to a small magnetic disk drive using small-diameter disks suitable for portable use.

Recently, magnetic disk drives have increased in both capacity and recording density, and found wide applications in fields such as home information appliances. This has led to an increasing need to reduce their size and thickness so that they can be used as portable devices. To satisfy such a need, there have been developed portable magnetic disk drives which are smaller and thinner than the 2.5″ and 3.5″ magnetic disk drives and support Compact Flash®, a standard for small memory cards (Compact Flash® is a registered trademark of SunDisk Corporation).

FIG. 6 is a diagram showing the configuration of a MicroDrivee marketed by IBM Corporation in U.S. in 1999 (MicroDrive® is a registered trademark of IBM Corporation). The figure shows a magnetic disk drive 1 with its top cover 5 removed, which includes: a magnetic disk 2 having a small diameter (25.4 mm); a magnetic head 3 for writing/reading information to/from the magnetic disk 2; and a connector 4 disposed on a side of the drive 1 for transmitting signals from the magnetic head 3 to an external device. FIG. 7 shows how to fit the magnetic disk drive 1 into a PC card 8. The user holds the magnetic disk drive 1 with its top cover 5 by his or her fingers and thumb placed on an area 7 on the drive located opposite to the side on which the connector 4 is mounted, and inserts the drive into the PC card 8. Two guide slots 6 are each formed in a respective one of two sides of the magnetic disk drive 1 (the sides perpendicular to the side on which the connector 4 is mounted). The magnetic disk drive 1 is inserted along guide rails 9 of the PC card 8 until the connector 4 of the magnetic disk drive 1 engages into a slot 10 of the PC card 8.

The above technique is disadvantageous in that when the magnetic disk drive is attached to or detached from the PC card (the target device), finger pressure is applied to the portion of the magnetic disk drive in which the magnetic head exists. Applying pressure to this portion may deform the top cover, interfering with the function of the magnetic head. As a result, the magnetic head might be brought into contact with the magnetic disk, causing abrasion, which might lead to damage to data due to abrasion of the magnetic disk. If the magnetic disk drive is pulled out of the PC card when the magnetic disk drive is still operating, the finger pressure applied to the top cover might affect the magnetic head such that it interferes with the retract mechanism of the magnetic head, making it impossible for the magnetic head to return to its retracted position. Furthermore, removing the magnetic disk drive from the PC card cuts off the power to the drive, stopping the rotation of the magnetic disk. If the magnetic head comes into contact with the stopped magnetic disk, the magnetic head might adhere to the magnetic disk, causing a failure at the subsequent startup of the drive.

### BRIEF SUMMARY OF THE INVENTION

Embodiments of the present invention provide a highly reliable magnetic disk drive whose magnetic head can properly function even if the magnetic disk drive is pulled out of its reader when the drive is still operating.

According to one aspect of the present invention, a magnetic disk drive comprises a connector which is disposed on one of two longer sides of the drive, the two long sides having a longer one of dimensions of the drive; two guide slots which are each formed in a respective one of two shorter sides of the drive, the two shorter sides having a shorter one of the dimensions of the drive, the two guide slots guiding the drive when it is attached to or detached from a target device; and a working area of the magnetic head which is within an area defined by the lengths of the connector and the two guide slots.

In some embodiments, the connector is disposed on one of the two longer sides of the drive as viewed from the disk surface side, the two longer sides having the longer one of the dimensions of the drive as viewed from the disk surface side, the one of the two longer sides being closer to the magnetic head than to the voice coil motor.

In some embodiments, the magnetic head is located closer to the one of the two longer sides of the drive on which the connector is disposed than to the other one of the two longer sides of the drive, the two longer sides having the longer one of the dimensions of the drive as viewed from the disk surface side.

In specific embodiments, two guide slots are each formed in a respective one of the two shorter sides of the drive as viewed from the disk surface side so that the drive can be attached to or detached from a target device, the shorter sides having the shorter one of the dimensions of the drive as viewed from the disk surface side.

Thus, the magnetic head is disposed close to the connector, making it possible to provide a highly reliable magnetic disk drive capable of preventing external pressure from being directly applied to the magnetic head even when the user attaches or detaches the magnetic disk drive to or from a target device such as a PC card.

### BRIEF DESCRIPTION OF THE DRAWINGS

FIG. 1 is a perspective view of a small magnetic disk drive according to a first embodiment of the present invention, showing its components.

FIG. 2 is also a perspective view of the small magnetic disk drive according to the first embodiment of the present invention with its top cover attached.

FIG. 3 is a plan view of the small magnetic disk drive according to the first embodiment of the present invention.

FIG. 4 is a plan view of a small magnetic disk drive according to a second embodiment of the present invention.

FIG. 5 is a diagram showing the portion of the magnetic disk drive according to the first embodiment of the present invention which will be fixed by inserting the magnetic disk drive into a PC card, and the working range of the magnetic head.

FIG. 6 is a plan view of a conventional small magnetic disk drive, showing its components.

FIG. 7 is a diagram showing how to fit a small magnetic disk drive into a PC card.

### DETAILED DESCRIPTION OF THE INVENTION

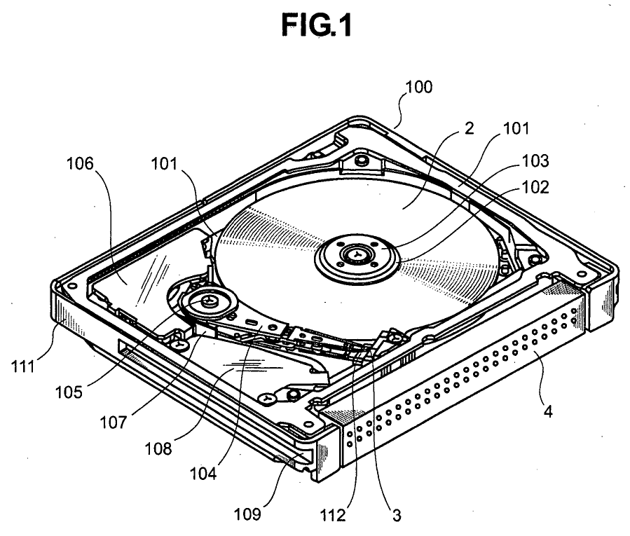

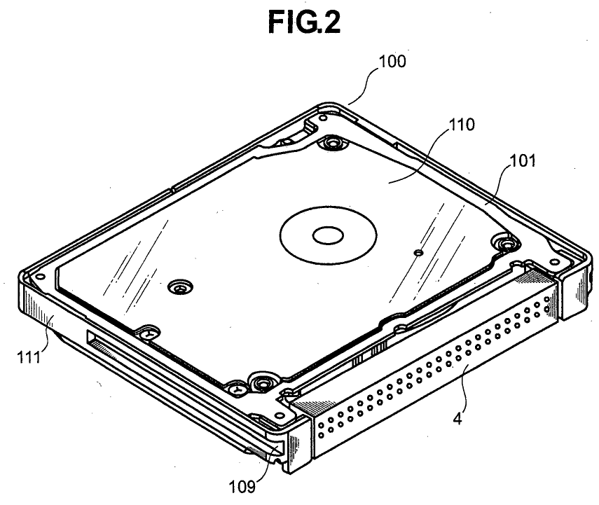

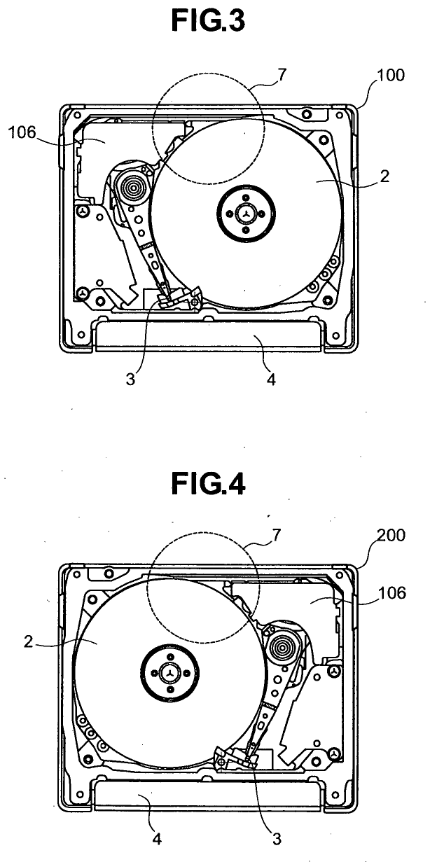

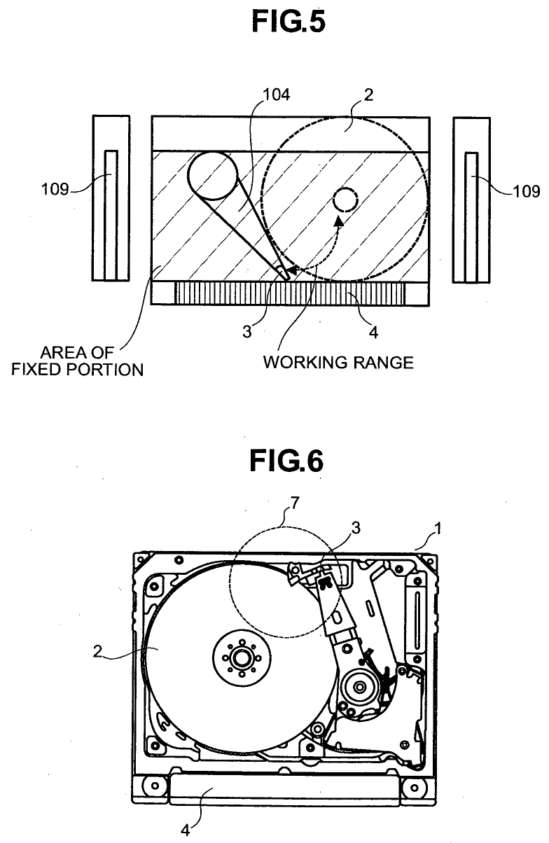

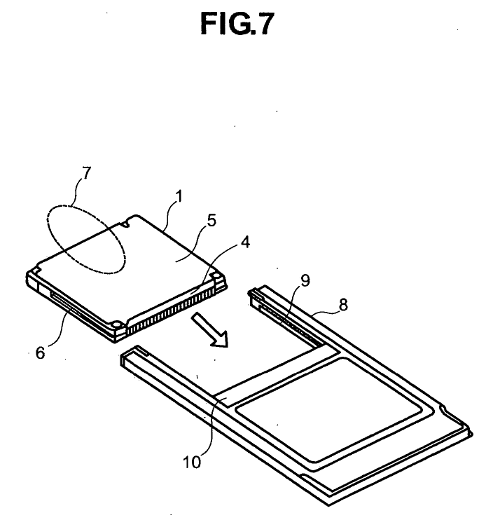

FIG. 1 is a perspective view of a magnetic disk drive according to a first embodiment of the present invention with its top cover removed. FIG. 2 is also a perspective view of the magnetic disk drive with its top cover attached. FIG. 3 is a plan view of the magnetic disk drive. FIG. 5 is a diagram showing the area of the portion of the magnetic disk drive which will be fixed by inserting the magnetic disk drive into a PC card, and the working range of the magnetic head.

A spindle motor 102 fixed onto a base 101 rotates a magnetic disk 2 fixed to (the shaft of) the motor with a clamp 103. An actuator arm 104 has a magnetic head 3 mounted on its tip. The actuator arm 104 is rotatably supported by a pivot 105 and rotated by a VCM (voice coil motor) 106 fixed onto the base 101. Rotating the actuator arm 104 moves the magnetic head 3 in the radial direction of the magnetic disk 2. Thus, the magnetic head 3 is positioned at a desired location to read or write information, or both. Signals from the magnetic head 3 go through an FPC (flexible printed circuit) 107 and are transmitted to an external device through a connector 4 attached to a side of a circuit board having electronic components 108 mounted thereon (the circuit board is mounted on the back side of the base 101).

With the reduced dimensions of the magnetic disk drive 100, the connector 4 is mounted on one of the two longer sides of the drive 100 having the longer one of the dimensions of the drive as viewed from the disk surface side (the magnetic disk drive 100 has dimensions of about 42.8 mm×36.5 mm×5 mm according to the form factor of Compact Flash). On the other hand, guide slots 109 for inserting the terminals of the connector 4 into the slots of the adapter of a PC card are formed in the two shorter sides of the drive having the shorter one of the dimensions of the drive as viewed from the disk surface side.

FIG. 2 is a plan view of the magnetic disk drive 100 of the present embodiment with the top cover 110 attached. The magnetic disk drive 100 is enclosed by the base 101 and the top cover 110. According to the present embodiment, the base 101 is formed by a press, and a frame 111, which was conventionally formed by casting, is formed of a shock absorbing material. The base 101 is encircled by the frame 111 of the shock absorbing material. It should be noted that the base 101 and the frame 111 may be formed together by aluminum die casting as a single unit according to a conventional method.

In the present embodiment, the connector 4 is disposed on the longer side of the magnetic disk drive closer to the magnetic head 3 than to the VCM 106. In other words, the magnetic head 3 is located closer to the one of the two longer sides of the drive on which the connector 4 is mounted than to the other one of the two longer sides as viewed from the disk surface side, the two longer sides having the longer one of the dimensions of the drive as viewed from the disk surface side.

In magnetic disk drives employing a load/unload arrangement, when the magnetic head 3 has been retracted from the magnetic disk 2, the head is held by a ramp mechanism 112 disposed along the side of the drive on which the connector 4 is mounted. It should be noted that magnetic disk drives employing a CSS (contact start and stop) arrangement do not require the ramp mechanism 112.

Thus, the magnetic head 3 is located near the connector 4, that is, it is outside the portion 7 to which finger pressure is directly applied when the user attaches or detaches the magnetic disk drive to or from a PC card, as shown in FIG. 3. The magnetic head 3 is not affected if the top cover 110 is deformed, since the magnetic head 3 is on the opposite side. Therefore, it is possible to avoid the risk of damage due to adhesion or abrasion between the magnetic head 3 and the magnetic disk 2, providing a highly reliable magnetic disk drive.

FIG. 5 is a diagram showing a top view and right and left side views of the magnetic disk drive of the present embodiment. The two guide slots 109 are each formed in a respective one of the two shorter sides of the drive as viewed from the surface of the magnetic disk 2 such that the guide slots are adjacent to the side on which the connector 4 is mounted. The guide slots 109 have a predetermined length in the longitudinal direction of the respective shorter sides of the drive corresponding to the length of the guide rails of the PC card. In FIG. 5, the arrowed broken line indicates the working range of the magnetic head 3 moved over the magnetic disk 2 by the actuator arm 104 according to the present embodiment. The working area of the magnetic head 3 is within the area in the magnetic disk drive whose three sides are defined by the lengths of the connector 4 and the guide slots 19, that is, the area of the fixed portion shown in FIG. 5.

When the magnetic disk drive 100 is attached to the adapter of a PC card, etc., the guide slots 109 are guided by the guide rails of the adapter so that the connector 4 engages into the slots (of the adapter). As a result, the portion of the drive indicated as “fixed portion” in FIG. 5 is fixed whereas the other portion of the drive is not fixed and therefore relatively unstable. The right and left sides of the area of the fixed portion are defined by both guide slots 109, while the lower side is defined by the connector 4. In the magnetic disk drive of the present embodiment, the working area of the magnetic head 3 is within the above area of the fixed portion, making it possible to stably perform read/write operation without being subjected to influence of external forces such as vibration.

FIG. 4 is a diagram showing a magnetic disk drive according to a second embodiment of the present invention. The basic configuration of the magnetic disk drive of the present embodiment for read/write operation is the same as that of the magnetic disk drive of the first embodiment.

The magnetic disk drive 200 of the present embodiment is different from the magnetic disk drive 100 of the first embodiment in that the magnetic disk drive 200 employs a different physical relationship between the magnetic disk 2 and the magnetic head 3 as viewed from the connector 4 side. Specifically, in the magnetic disk drive 100 of the first embodiment, the VCM 106 is disposed at the upper-left corner of the base 101 and the disk 2 is disposed on the right-hand side of the base 101 as viewed from the connector 4 side. In the magnetic disk drive 200 of the present embodiment, on the other hand, the VCM 16 is disposed at the upper-right corner of the base 101 and the magnetic disk 2 is disposed on the left-hand side of the base 101 as viewed from the connector 4 side.

Also in the present embodiment, the connector 4 is disposed on the longer side of the base closer to the magnetic head 3 than to the VCM 16. In other words, the magnetic head 3 is located close to the side of the base on which the connector 4 is mounted. Therefore, like the first embodiment, the configuration of the present embodiment makes it possible to avoid the risk of damage due to adhesion or abrasion between the magnetic head 3 and the magnetic disk 2, providing a highly reliable magnetic disk drive.

As described above, embodiments of the present invention can provide a highly reliable magnetic disk drive capable of preventing external pressure from being directly applied to the magnetic head even when the user attaches or detaches the magnetic disk drive to or from a target device such as a PC card.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

1. A magnetic disk drive comprising:
a magnetic disk;
a spindle motor configured to rotate said magnetic disk;
a magnetic head configured to read/write information to/from said magnetic disk;
an actuator arm having said magnetic head mounted on a tip thereof;
a pivot configured to rotatably support said actuator arm;
a VCM configured to drive said actuator arm;
electronic components configured to process a signal from said magnetic head;
a card having said electronic components mounted thereon; and
a connector provided for said card;
wherein said connector is disposed on one of two longer sides of said magnetic disk drive, said two longer sides having a longer one of dimensions of said magnetic disk drive;
wherein two guide slots are each formed in a respective one of two shorter sides of said magnetic disk drive, said two shorter sides having a shorter one of said dimensions; and
wherein a working area of said magnetic head is within an area whose three sides are defined by lengths of said connector and said two guide slots.

2. The magnetic disk drive as recited in claim 1, wherein said longer dimension is about 42.8 mm and said shorter dimension is about 36.4 mm.

3. A magnetic disk drive comprising:
a magnetic disk;
a spindle motor configured to rotate said magnetic disk;
a magnetic head configured to write/read information to/from said magnetic disk;
an actuator arm having said magnetic head mounted on a tip thereof;
a pivot configured to rotatably support said actuator arm;
a VCM configured to drive said actuator arm;
electronic components configured to process a signal from said magnetic head;
a card having said electronic components mounted thereon; and
a connector provided for said card;
wherein said connector is disposed on one of two longer sides of said magnetic disk drive, said two longer sides having a longer one of dimensions of said magnetic disk drive, said one of said two longer sides being closer to said magnetic head than to said VCM.

4. The magnetic disk drive as recited in claim 3, wherein two guide slots are each formed in a respective one of two shorter sides of said magnetic disk drive, said two shorter sides having a shorter one of said dimensions.

5. The magnetic disk drive as recited in claim 4, wherein said longer dimension is about 42.8 mm and said shorter dimension is about 36.4 mm.

6. A magnetic disk drive comprising:
a magnetic disk;
a spindle motor configured to rotate said magnetic disk;
a magnetic head configured to write/read information to/from said magnetic disk;
an actuator arm having said magnetic head mounted on a tip thereof;
a pivot configured to rotatably support said actuator arm;
a VCM configured to drive said actuator arm;
electronic components configured to process a signal from said magnetic head;
a card having said electronic components mounted thereon; and
a connector provided for said card;
wherein said connector is disposed on one of two longer sides of said magnetic disk drive, said two longer sides having a longer one of dimensions of said magnetic disk drive; and
wherein said magnetic head is located closer to said one of said two longer sides on which said connector is disposed than to the other one of said two longer sides, said two longer sides having said longer one of said dimensions.

7. The magnetic disk drive as recited in claim 6, wherein two guide slots are each formed in a respective one of two shorter sides of said magnetic disk drive, said two shorter sides having a shorter one of said dimensions.

8. The magnetic disk drive as recited in claim 7, wherein said longer dimension is about 42.8 mm and said shorter dimension is about 36.4 mm.

9. A magnetic disk drive comprising:
a magnetic disk;
a spindle motor configured to rotate said magnetic disk;
a magnetic head configured to write/read information to/from said magnetic disk;
an actuator arm having said magnetic head mounted on a tip thereof;
a pivot configured to rotatably support said actuator arm;
a VCM configured to drive said actuator arm;
electronic components configured to process a signal from said magnetic head;
a card having said electronic components mounted thereon; and
a connector provided for said card;
wherein said connector is disposed on one of two longer sides of said magnetic disk drive, said two longer sides having a longer one of dimensions of said magnetic disk drive; and
wherein a ramp mechanism is disposed along said one of said two longer sides on which said connector is disposed, said ramp mechanism holding said magnetic head retracted from said magnetic disk.

10. The magnetic disk drive as recited in claim 9, wherein two guide slots are each formed in a respective one of two shorter sides of said magnetic disk drive, said two shorter sides having a shorter one of said dimensions.

11. The magnetic disk drive as recited in claim 10, wherein said longer dimension is about 42.8 mm and said shorter dimension is about 36.4 mm.

12. A magnetic disk drive comprising:
a magnetic disk;
a spindle motor configured to hold and rotate said magnetic disk;
a magnetic head configured to write/read information to/from said magnetic disk;
an actuator having said magnetic head mounted on one end thereof, to move said magnetic head in a radial direction of said magnetic disk;
a circuit board having electronic components mounted thereon; and
a connector attached to a side of said circuit board, said side being close to said magnetic head.

13. The magnetic disk drive as recited in claim 12, wherein said side to which said connector is attached has a longer one of dimensions of said circuit board.

14. The magnetic disk drive as recited in claim 12, further comprising a ramp mechanism on which said magnetic head is parked when said magnetic head has been retracted from said magnetic disk, said ramp mechanism being near said connector.

15. A magnetic disk drive comprising:
a magnetic disk;
a spindle motor configured to hold and rotate said magnetic disk;
a circuit board having electronic components mounted thereon and having a connector attached to a side thereof;
a magnetic head, located on a side close to said connector, to write/read information to/from said magnetic disk; and
an actuator having said magnetic head mounted on one end thereof, to move said magnetic head in a radial direction of said magnetic disk.

16. The magnetic disk drive as recited in claim 15, wherein said side to which said connector is attached has a longer one of dimensions of said circuit board.

17. The magnetic disk drive as recited in claim 15, further comprising a ramp mechanism on which said magnetic head is parked when said magnetic head has been retracted from said magnetic disk, said ramp mechanism being near said connector.

18. A magnetic disk drive comprising:
a magnetic disk;
a spindle motor configured to hold and rotate said magnetic disk;
a magnetic head configured to write/read information to/from said magnetic disk;
an actuator arm having said magnetic head mounted on a tip thereof;
an actuator configured to rotate said actuator arm around a pivot so as to move said magnetic head in a radial direction of said magnetic disk;
a circuit board having electronic components mounted thereon; and
a connector attached to one of two longer sides of said circuit board, said two longer sides having a longer one of dimensions of said circuit board, said one of said two longer sides being farther from said actuator than the other one of said two longer sides is.

19. The magnetic disk drive as recited in claim 18, further comprising a ramp mechanism on which said magnetic head is parked when said magnetic head has been retracted from said magnetic disk, said ramp mechanism being near said connector.

20. A magnetic disk drive comprising:
a magnetic disk;
a spindle motor configured to hold and rotate said magnetic disk;
a circuit board having electronic components mounted thereon and having a connector attached to a side thereof, said side having a longer one of dimensions of said circuit board;
a magnetic head configured to write/read information to/from said magnetic disk;
an actuator arm having said magnetic head mounted on a tip thereof; and
an actuator, disposed on a side far from said connector, to rotate said actuator arm around a pivot so as to move said magnetic head in a radial direction of said magnetic disk.

21. The magnetic disk drive as recited in claim 20, further comprising a ramp mechanism on which said magnetic head is parked when said magnetic head has been retracted from said magnetic disk, said ramp mechanism being near said connector.

22. A magnetic disk drive comprising:
a base;
a spindle motor fixed to said base;
a magnetic disk held and rotated by said spindle motor;
a magnetic head configured to write/read information to/from said magnetic disk;
an actuator, fixed to said base and having said magnetic head mounted on one end thereof, to move said magnetic head in a radial direction of said magnetic disk;
a circuit board having electronic components mounted thereon;
a connector attached to a side of said circuit board, said side being close to said magnetic head; and
two guide slots each formed in a respective one of two sides of said base, said two sides sandwiching said connector.

23. The magnetic disk drive as recited in 22, wherein said side to which said connector is attached has a longer one of dimensions of said circuit board.

24. The magnetic disk drive as recited in claim 22, further comprising a ramp mechanism on which said magnetic head is parked when said magnetic head has been retracted from said magnetic disk, said ramp mechanism being near said connector.

25. A magnetic disk drive comprising:
a base;
a spindle motor fixed to said base;
a magnetic disk held and rotated by said spindle motor;
a magnetic head configured to write/read information to/from said magnetic disk;
an actuator, fixed to said base and having said magnetic head mounted on one end thereof, to move said magnetic head in a radial direction of said magnetic disk;
a circuit board having electronic components mounted thereon;
a connector attached to a side of said circuit board, said side being close to said magnetic head;
a shock absorbing material encircling said base; and
two guide slots each formed in a respective one of two sides of said shock absorbing material, said two sides sandwiching said connector.

26. The magnetic disk drive as recited in 25, wherein said side to which said connector is attached has a longer one of dimensions of said circuit board.

27. The magnetic disk drive as recited in claim 25, further comprising a ramp mechanism on which said magnetic head is parked when said magnetic head has been retracted from said magnetic disk, said ramp mechanism being near said connector.
